(19) United States
(12) Patent Application Publication
(10) Pub. No.: US 2010/0099005 A1
(43) Pub. Date: Apr. 22, 2010

(54) VAPOR FED DIRECT HYDROCARBON ALKALINE FUEL CELLS

(76) Inventors: Xiaoming Ren, Menandsm, NY (US); Paolo Bert, Como (IT)

Correspondence Address: Jay S Cinamon, 666 Thid Avnue 10th Floor, New york, NY, 10017, US

(21) Appl. No.: 12/451,301

(22) PCT Filed: May 15, 2007
(86) PCT No.: PCT/EP2007/054714

§ 371 Date: Nov. 3, 2009

(51) Int. Cl. H01M 2/02

(52) U.S. Cl. 429/34

(57) ABSTRACT

A direct hydrocarbon fuel cell device pertaining direct electro-oxidation of hydrocarbon fuels at the anode, which is separated electronically from the cell cathode by an alkaline medium, together with a fuel container, fuel delivery, and reaction product releasing system is disclosed. The fuel cell is constructed in such a manner that highly concentrated fuel is added to the cell anode chamber and transformed into fuel vapor through a fuel vapor permeable membrane before the fuel reaches the cell anode. At the cell anode, the hydrocarbon fuel is consumed and at the cell cathode oxygen reduction takes place, and water as one of the fuel cell reaction products is evaporated off at cell cathode so that there is no need for recirculation of unreacted fuel at the cell anode or water at the cell cathode. Compared to the prior art, the present invention for a direct hydrocarbon fuel cell is more suitable for portable electronics applications by maximizing the energy content in the fuel package, optimizing the fuel cell performance while minimizing the control system complexity, and lowering the cost by using non-noble metal based catalysts while achieving the needed fuel cell performance and conversion efficiency.

### BACKGROUND OF THE INVENTION

1. Field of the Invention

The present invention relates generally to the field of fuel cells, and more specifically, to a direct alkaline fuel cell device pertaining direct oxidation of hydrocarbon fuels at the anode, which is separated electronically from the cell oxygen reduction cathode by an alkaline hydroxyl ion conducting medium, together with a fuel container, fuel delivery, and reaction product release system.

2. Background Information

Fuel cells are devices in which the chemical energy stored in the fuel and oxidant are directly converted to electrical energy by the electrochemical reactions at two electrodes separated electronically by an ionic conducting medium. A variety of chemical compounds may be used as a fuel for the fuel cells, depending upon the fuel cell design and operating conditions. Hydrocarbon fuels, such as methanol, ethanol, ethylene glycol, glycerol, sugar or gasoline, are attractive choices as the fuels for fuel cells because of their high specific energy content and convenience to store and carry.

Fuel cells and fuel cell systems have been the subject of intensified recent development because of their promised high energy conversion efficiency while emitting comparatively low levels of environmentally harmful substances.

The hydrocarbon fueled fuel cell systems may be divided into “reformer-based” systems and “direct oxidation” systems. In the reform-based fuel cell systems, the fuel is processed initially to extract hydrogen from the fuel, and then the hydrogen rich stream is fed to a hydrogen/air fuel cell. In the direct oxidation fuel cells, the fuel is fed directly into the cell anode without the need for the initial internal or external processing. Most currently developed fuel cell systems are reformer-based. However fuel processing is complex, expensive, ill-fitted for dynamic power demand, and requires significant volume. Consequently, reformer based systems are limited to comparatively high power or stationary applications, while the direct fueled hydrocarbon fuel cells are promising candidates for the portable power applications, where the simplicity, volume, size and cost are on the top of a list of important attributes.

The adaptation of fuel cell systems to mobile power applications, however, is not straightforward because of the technical difficulties associated with existing fuel cell systems. For a reform-based fuel cell system, it is very difficult to reform the complex carbonaceous fuels in a simple and cost effective manner, and within acceptable weight and volume limits. For a fuel cell system based on using hydrogen as the fuel, a safe and efficient storage for the substantially pure hydrogen (which is a gas under the relevant operating conditions) remains a challenging problem. Currently, hydrogen gas can only be stored at high pressure in gaseous form or at cryogenic temperatures in liquid form or in heavy absorption materials in order to achieve useful energy densities. It has been found, however, that a practical means for storing hydrogen is in a hydrogen rich compound with relatively weak chemical bonds, such as methanol or an aqueous methanol solution (and to a lesser extent, ethanol, propane, butane and other carbonaceous liquids or aqueous solutions thereof). In particular, direct oxidation fuel cell system, such as direct methanol fuel cells (DMFCs), using protonically conductive polymer electrolyte membrane are being developed for commercial productions in powering portable electronic devices.

Direct oxidation fuel cell systems may be better suited for a number of applications in smaller mobile electronic devices (e.g., mobile phones, handheld and laptop computers), as well as in some larger applications. The most commonly adopted direct oxidation fuel cells are based on using proton conducting polymer electrolyte membrane placed between the anode and cathode. Typically, in such a direct oxidation fuel cell, a carbonaceous liquid fuel in an aqueous solution (typically aqueous methanol) is fed to the anode face of a membrane electrode assembly (MEA). The MEA contains a protonically-conductive but electronically non-conductive membrane (PCM). One example of a commercially available PCM is Nafion® (a registered trademark of E.I. Dupont de Nours and Company) membranes, a type of cation exchanging membrane comprised of perfluorocarbon polymers with side chain termini of perfluorosulfonic acid groups, in a variety of thicknesses and equivalent weights. Typically, a catalyst which enables direct electro-oxidation of the fuel is disposed on one major surface of the PCM to form anode (or is otherwise present in the anode chamber of the fuel cell). The anodic reaction involving fuel and water molecules generates protons and electrons. The protons migrate through the PCM, which is impassable to the electrons. The electrons pass through the external circuit connecting the load to reunite with the protons and oxygen molecules in the cathodic reaction, catalyzed by a cathode catalyst deposited on the other major surface of the PCM.

One example of a direct oxidation fuel cell system is a direct methanol fuel cell system or DMFC system. In a DMFC system, methanol in an aqueous solution is used as the fuel (the “fuel mixture”), and oxygen, preferably from ambient air, is used as the oxidant.

There are two electrode reactions that occur in a DMFC which allow a DMFC system to provide electricity to power consuming devices: the anodic disassociation of the methanol and water in the fuel mixture into CO₂, protons, and electrons; and the cathodic combination of protons, electrons and oxygen into water. There are many problems with DMFCs. One is that some methanol may pass through the membrane, from the anode chamber of the fuel cell to the cathode chamber of the fuel cell. This phenomenon, known as methanol crossover, may be limited by introducing a dilute aqueous methanol solution as fuel, rather than a concentrated solution. The other is the sluggish rates of electrode reactions in the acidic medium. Consequently, noble metals at very high loading levels are needed to provide the minimum cell power density and fuel conversion efficiency for any practical application. With the combination of using noble catalysts and a strong acidic reaction medium, it has been proved that the fuel choice for the direct oxidation fuel cell systems using PCM is limited to a few compounds that do not contain carbon-carbon bond. For example, when ethanol is used as the fuel, the anodic reaction of ethanol electro-oxidation precedes mostly to forming acetic acid only, instead of the preferred complete oxidation process to form carbon dioxide. In this case, the fuel cell only extracted 4 out of the 12 available electrons from each ethanol molecule, thus limiting the maximum achievable energy conversion efficiency at less than 34%.

It is thus critical to enhance the electrode reaction rates, ensure the fuel electro-oxidation proceed completely to form carbon dioxide. It is also very important to minimize the complexity and volume of such systems by removing the concentration control of fuel solution, and by increasing the fuel content of the fuel cell power pack. It is also important to reduce the cost and complexity of manufacturing in large-scale production by removing the need to use catalysts based noble metals. In addition, by removing the need of using noble metal as the cell cathode catalysts, problems associated with fuel crossover found in the direct hydrocarbon fueled fuel cells using proton conducting membranes can be eliminated.

A direct oxidation fuel cell using alkaline medium separator between the anode and cathode may thus be a better power system to provide the increasing power needs for the portable electronics. In the alkaline medium, both electrode reactions are considerably facile, such that high power output at a high energy conversion rate can be achieved at around the room temperature. Additionally, the fast electrode reaction rates in the alkaline medium make it possible to use low cost non-noble metal catalysts, thus considerably reduce the cost of the fuel cell system, and overcome the limitation and dependency on the scarcity of the noble metal resources for the mass production of such a fuel cell system. It is especially advantageous to use the non-noble metal catalysts, such as Hypermec anode catalysts for the direct oxidation of hydrocarbon fuels, and Hypermec cathode catalyst for the oxygen reduction. Additional benefits of using such non-noble metal cathode catalysts are realized by its selective reduction of oxygen without catalyzing the oxidation of the fuel that may crossover from the anode side. This not only avoids the waste of fuel by preventing its consumption at the cell cathode, it also avoids the polarization of, and sometimes poisoning effect to, the cell cathode. This is in contrast to the situation encountered with the noble metal based cathode catalysts, which promote complete consumption, equaling to direct combustion, of the crossover fuel at the catalyst surface, and at the same time, the fuel cell cathode performance is degraded because of the added polarization of cathode to support the combustion reaction.

Traditionally, the alkaline fuel cells are based on feeding the fuel cell anode with a solution containing the fuel and an alkaline electrolyte, such as potassium hydroxide. In order to avoid precipitations of carbonates, the concentration of the alkaline solution is limited to within 25 wt %. Also, in order to avoid excessive fuel crossover and fuel loss from its evaporation at the cell cathode, the fuel concentration is limited to within a few percentages in the fuel solution fed to the cell anode. Such a system is obviously not well suited for applications of portable electronics, where high energy density is one of the key performance criteria.

The typical electrode reactions of an alkaline fuel cell using hydrocarbon fuel are described here using ethanol as the fuel for example. A hydroxide ion conducting medium separates the anode catalyst layer from the cathode catalyst layer. Anionic conducting polymer electrolyte membranes such as A006, A011, BA202 from Tokuyama, and ADP08 from Sovay can be used as the hydroxide ion conducting medium. Also, in the case of using liquid electrolyte in the fuel feed stream, a porous electronically non-conducting material, such as porous polypropylene, porous PTFE, porous woven or non-woven fabrics, porous glass frit, asbestos, alkaline doped PBI membrane, alkaline soaked PEO, alkaline soaked PEO-PVA, and other similar materials can be used as the hydroxide ion conducting medium. In the cathode catalyst layer, oxygen molecules from the air are electro-reduced to form hydroxide ions according to Eq. (1)

3O₂+6H₂O+12e⁻→OH⁻ (1)

The hydroxide ions thus produced at the cell cathode migrate through the hydroxide ion conducting medium to reach the anode catalyst layer, where ethanol molecules are electro-oxidized to form carbon dioxide according to Eq. (2)

CH₃CH₂OH+12OH⁻→2CO₂+9H₂O+12e⁻ (2)

The combined fuel cell reaction of the anode and cathode electrode reactions is given by Eq. (3)

CH₃CH₂OH+3O₂→3H₂O+2CO₂ (3)

In order to reach a sustainable and optimal performance of the fuel cell, water content at the cell cathode need to be carefully managed so as to avoid cathode dehydration or cathode flooding.

In an operating fuel cell, water molecules are removed at the cell cathode by the following three processes: 1) water consumption in the cathodic electrode reaction according to Eq. (1); 2) water flux from cathode to anode by the electro-osmotic drag of hydroxide ions when they migrate from the cathode to anode; and 3) water flux leaving cathode into the air stream by its evaporation.

At the cell anode, water molecules are produced by the anodic electrode reaction according to Eq. (2), with additional water molecules arriving at the anode by the electro-osmotic drag of hydroxide ions from the cell cathode. For the optimal fuel cell operation, it is therefore desirable to facilitate the transport of the excess water from the cell anode to cell cathode, preferably internally through the hydroxide conducting separator.

Additional challenge of the water management is to balance water production rate according to Eq. (3) to the water releasing rate from the cell. There are two routes by which water molecules can leave the fuel cell. One is with CO₂ when it is released as water saturated stream from cell anode or cathode. The second one is from the cell cathode, where water is evaporated into the air exhaust stream. Excessive water loss beyond water production rate according to Eq. (3) requires additional water being carried from supply, which must be carried at the start together with the fuel supply, thus diluting the energy content of the fuel package. With tradition fuel cell system design, a dilute fuel stream is fed to the cell anode, with fuel and water being added to the fuel steam to compensate their consumptions and losses so as to maintain a constant fuel concentration of the fuel fed to cell anode. Often, such a system design is complex, expensive and lacks the desired reliability for many power applications.

Thus, there remains a need for a direct oxidation hydrocarbon fuel cell system with a simplified fuel feed and control systems to achieve the desired system simplicity and operation reliability, which are critically needed to facilitate large-scale production of such a fuel cell system for mass manufacturing. Additionally, it is desirable to supply highly concentrated, or neat hydrocarbon fuels to the fuel cell anode with a fuel cartridge that contains no electrolyte so as to minimize the hazards involved with fuel cartridge and those in refueling the fuel cells, and at the same time, increase the fuel content in the fuel cartridge.

It is thus an object of the present invention for a direct hydrocarbon fuel cell that is more suitable for portable electronics applications by maximizing the energy content in the fuel package, optimizing the fuel cell performance while minimizing the control system complexity, simplifying the carbon dioxide removal by providing direct ventilation after its generation at the fuel cell anode, and lowering the cost by using non-noble metal based catalysts while achieving the needed fuel cell performance and conversion efficiency.

### SUMMARY OF THE INVENTION

These and other advantages are provided by the present invention in which a direct hydrocarbon fuel cell device pertaining direct electro-oxidation of hydrocarbon fuels at the anode, which is separated electronically from the cell cathode by an alkaline medium, together with a fuel container, fuel delivery, and reaction product releasing system is provided.

In one embodiment of the invention, the alkaline fuel cell is fed at the cell anode with the fuel vapor originated from a highly concentrated hydrocarbon aqueous solution or neat hydrocarbon fuels from the fuel cartridge inserted inside the fuel cell system. The highly concentrated hydrocarbon aqueous solution or neat hydrocarbon fuels can also be directly injected into a reservoir placed inside the fuel cell system. The concentrated hydrocarbon aqueous solution or neat hydrocarbon fuel from the fuel cartridge or reservoir contains no electrolyte, and is separated from its vapor with an evaporative membrane or other micro-porous materials, which is disposed inside the cell anode compartment between the fuel reservoir and fuel cell anode electrode. Fuel in liquid form is presented at one side of the evaporative membrane while fuel in vapor form at the other side of the evaporative membrane. The fuel vapor has a direct access to the fuel cell anode catalyst layer. The anodic electrode reaction produces CO₂, which is released through openings located between the fuel evaporation membrane and fuel cell anode, or through the membrane electrode assembly at the cell cathode. Part of the water produced from the anodic electrode reaction of such an alkaline fuel cell is forced to flow through the polymer electrolyte membrane from cell anode to cell cathode by a positive pressure intentionally built-up with CO₂ produced at the anode side of the MEA. In addition, water transport from the cell anode to cell cathode is further facilitated by a hydrodynamic pressure intentionally designed with the MEA structure. In such a MEA, the anode catalyst layer is made to be highly hydrophobic and the cathode catalyst layer to be highly hydrophilic. As the result, a hydrodynamic pressure arises from the hydrophobicity difference between a highly hydrophobic anode catalyst layer and a highly hydrophilic cathode catalyst layer, and water is pushed out of the anode catalyst layer and pulled into the cathode catalyst layer. With these water management design, the water needs at the cell cathode for the cathodic electrode reaction and OH— conduction of the polymer electrolyte can be self-sustained by the water production from cell electrode reactions. This is unlike a direct hydrocarbon fuel cell fed with a liquid fuel solution directly to the cell anode, where an external mechanical pumping system must be used for recovering water from exhaust and returning the recovered water to the system. Additional benefits derived from the vapor fed direct hydrocarbon fuel cell include high energy density by removing the need to carry water, insensitivity to its orientation along gravity, withstanding frozen temperature, simple and reliable operation, low potential hazardous exposure of the corrosive electrolyte to end user, and low cost in mass production. The anode catalyst layer and cathode catalyst layer with specially designed hydrophobicity, a membrane or microporous medium that separate the liquid fuel and its fuel vapor, and a suitable OH— conductive polymer electrolyte membrane or porous medium soaked with an alkaline hydroxide solution are the key components for the vapor fed direct hydrocarbon fuel cell to work well.

In accordance with another aspect of this embodiment of the invention, fuel is delivered to the fuel cell anode catalyst layer in vapor form from solidified fuel source, which contains no electrolyte, and is placed inside the anode compartment. The highly concentrated hydrocarbon aqueous solution can be solidified by adding a variety of gelling agents to form fuel gels.

In accordance with another aspect of this embodiment of the invention, fuel is delivered to the fuel cell anode catalyst layer in vapor form by pumping the highly concentrated fuel solution or neat fuel on to an evaporating pad placed inside the anode compartment. The liquid hydrocarbon fuel is then evaporated into its vapor form either by utilizing the waste heat generated from the fuel cell reactions, or by the waste heat in combination with added heat. The added heat can be provided by electric heating, or by fuel combustion, or by fuel combustion catalyzed by catalysts, such as Pt on a variety of supporting materials.

In accordance with another aspect of the embodiments of the invention, the fuel evaporating membrane material is incorporated into the anode backing, and becomes part of the anode backing components. One example is to laminate the fuel evaporating polymer membrane material on the outer surface of the original anode backing. The combined anode backing electrode contacts the liquid fuel at its outer surface while only the fuel vapor exists at its inner surface and has direct access to the fuel cell anode catalyst layer.

In accordance with another aspect of the embodiments of the invention, a hydrophobic anode backing is used to contact a hydrophobic anode catalyst layer, and a hydrophobic cathode backing is used to contact a hydrophilic cathode catalyst layer. The hydrophobic anode backing prevents excessive water loss from the cell anode, and the hydrophobic cathode backing prevents excessive water loss from the cell cathode. The hydrophobicity difference between the anode catalyst layer and cathode catalyst layer provide additional driving force to move water from the cell anode to cell cathode by the capillary force arising within the microporous catalyst layers.

In accordance with another aspect of the embodiments of the invention, the fuel cell anode catalyst and cathode catalyst are preferably non-noble metal. Examples of such catalysts are Hypermec anode catalyst and Hypermec cathode catalyst.

In accordance with another aspect of the embodiments of the invention, optimal water content within the fuel cell electrodes is maintained by adjusting air feed rate to the cell cathode so as to control the water evaporation rate to match the water generation from the fuel consumption, and in this case, the cell current provided. It is critical that an optimal water level is achieved to avoid the degrading effects on fuel cell performance from the cathode flooding or cathode drying-out.

In accordance with another aspect of the embodiments of the invention, optimal water content within the fuel cell electrodes is be further more maintained by adjusting fuel cell temperature through fuel cell operating power output. The fuel cell power output can be adjusted by the fuel feed rate, and with a given fuel feed rate by the fuel cell operating voltage. With a higher fuel cell operating power, a higher rate of waste heat is generated, thus raises the cell temperature higher. The higher difference between cell temperature above the ambient temperature increases water removal from the cell cathode by evaporation.

### BRIEF DESCRIPTION OF THE DRAWINGS

The invention description below refers to the accompanying drawings, of which:

FIG. 1 is a block diagram of a prior art of direct hydrocarbon alkaline fuel cell system;

FIG. 2 is a schematic cross section of one embodiment of the membrane electrode assembly (MEA) of the present invention, which includes a fuel vapor permeable membrane placed in the anode chamber and having intimate contact with the liquid fuel at fuel feed side;

FIG. 3 is a schematic cross section of one embodiment of the liquid fuel feed from a fuel cartridge to the fuel vapor permeable membrane placed in the anode chamber;

FIG. 4 is a schematic cross section of one embodiment of the membrane electrode assembly;

FIG. 5 is a an alternative embodiment of the membrane electrode assembly, which enables more compact construction and using nonconductive plates for cell compression and reactants distribution;

FIG. 6 is a schematic illustration of fuel feed, and CO2 transportation through the membrane and ventilation at the cell cathode;

FIG. 7 is a block diagram of one embodiment of a direct hydrocarbon alkaline fuel cell system with air breathing cathode;

FIG. 8 is a block diagram of one embodiment of a direct hydrocarbon alkaline fuel cell system with active air feed, including a fuel and water vapor recovering means;

FIG. 9 is a schematic diagram showing cell components of an air-breathing VFDHAFC unit containing only a single cell;

FIG. 10 is a schematic diagram of a VFDHAFC stack fed with forced air at stack cathode and re-circulated hydrocarbon fuel vapor at stack anode compartment;

### DETAILED DESCRIPTION OF AN ILLUSTRATIVE EMBODIMENT

Previous arts of direct electro-oxidation of hydrocarbon (mostly methanol) fuel cells are based on feeding cell anode with a dilute methanol aqueous solution in liquid form, usually a methanol solution of methanol concentration less than 2 wt. % and using a protonic conductive polymer electrolyte membrane. Protonic conductive polymer electrolyte membrane, such as Nafion membrane, is used as the protonic conductor and separator between cell anode and cell cathode. The anode catalyst layer contains the recast ionomer mixed with high surface area catalyst particles, such as PtRu alloy either supported on carbon or unsupported, for the methanol electro-oxidation. The cathode catalyst layer contains the recast ionomer mixed with high surface area catalyst particles, such as Pt either supported on carbon or unsupported, for oxygen electro-reduction. Because of the high protonic conductivity of the polymer electrolyte, such as perfluorosulphonic acid membranes, achieved at near ambient temperature combined with the advantage of using methanol as the fuel, direct methanol fuel cells have tremendous potentials as the future power systems, ranging from battery replacement to power engines of future electric vehicles. To minimize the problem of methanol crossover through the polymer electrolyte membrane from the cell anode side to the cell cathode side, the concentration of the methanol solution fed to the anode is kept low, for example, less than 4.0 M or 2% methanol in water by weight. For this type of direct methanol fuel cell, referred to as the liquid feed direct methanol fuel cell (LFDMFC), the major reaction products of anode electrode process is CO₂, which is separated and then vented out as CO₂ gas from the anode fluid, which is then re-circulated. The methanol concentration of the anode fluid has to be maintained to the desired level by injecting a proper amount of water and neat methanol to make up the consumption and loss of methanol and water, usually based on feedback from a methanol concentration sensor implanted in the anode fluid re-circulating loop. In order to minimize the methanol crossover, the LFDMFC are preferably fed with as low a methanol concentration solution as possible without creating excessive concentration polarization on the anode process, i.e., the LFDMFC is operated in a lean feed mode. Because the anode catalyst layer and membrane in a LFDMFC is always in contact with a dilute methanol solution, the water activity at the anode side of the membrane remains near unity at all time, in despite of the cell current density. Considerable drawbacks exist for LFDMFC, and some are listed in the following paragraphs:
1. A solution of low methanol concentration or/and pure water has to be carried on board. This lowers the total energy density of the system, and it also renders the system to the potential damages when the fuel cell system becomes frozen at sub-zero ° C. environmental temperature.
2. There is a high water flux from the cell anode to the cell cathode by electro-osmotic drag of the fluid in the polymer electrolyte membrane by protonic current. Despite of the operating current density of a LFDMFC, the water activity at the anode side of the membrane always maintains close to unity. For majority polymer electrolyte membranes, the water drag coefficient, a measure of the number of water molecules pushed across the membrane with a proton in the absence of water concentration gradient, is about 2 at room temperature and increased to 3 at 60° C. For each methanol molecule electro-oxidized at the anode, six protons are produced, and carry with them 18 molecules of water across the membrane if the electro-osmotic drag coefficient of the membrane is 3, such as at 60° C. Such a large water flux from the cell anode to cell cathode creates enormous water unbalance for the LFDMFCs. All the liquid water and part of the water vapor in the cathode air exhaust recovered with a condenser must be returned to the cell anode side in order to maintain water balance (i.e., the total amount of water loss from the cell, usually as water vapor in the cathode exhaust stream released to environment, is no more than the water produced by the methanol oxidation). Consequently, the control and operation of a LFDMFC become complex and less reliable. The thermal balance requirement coupled with the water balance requirement further increases the complexity of system and control. It is hoped that a superior membrane that conducts only proton but not water (and methanol) could solve these problems. Such a future membrane must be based on entirely different proton conducting mechanism, and is not yet known of for a polymer protonic conductor at room temperature to date.
3. Because a large water flux emerges at the cathode in a LFDMFC, a liquid water pool can easily cover the cathode catalyst layer and limit oxygen access, and the performance of the air cathode becomes poor and unstable, especially with a limited amount of air feed. Increasing air feed rate beyond 3 stoichiometry in order to alleviate cathode flooding is limited by the difficulty of recovering a substantial amount of water vapor from the cathode air exhaust with a condenser, which must work at an extremely low efficiency due to a small temperature gradient.
4. Also because of a large water flux emerged from the cathode side of the membrane in a LFDMFC, the recast ionomer component in the cathode catalyst layer is potentially unstable over a long term of operation. As the results, the oxygen reduction activity of the cathode catalyst layer decreases. Additionally, the recast ionomer leached from the catalyst layer spreads outward and covers the surface of the backing, causing the backing loss its desired hydrophobicity against cathode flooding.
5. With liquid methanol solution feed at the anode in a LFDMFC, metal ion contaminants, either from corrosion of stack components or from impurity, can readily reach the catalyst layer and polymer electrolyte membrane, and replace the mobile protons of the polymer electrolyte phase in the catalyst layer and polymer electrolyte membrane. As a result, the protonic conductivity of the polymer electrolyte and the catalyst activity decrease. The metal ion contaminates can also poison the catalyst by covering its surface.
6. Because of the need to recover and store the liquid water and the need to separate CO₂ from the anode recirculating fluid, the operation of a LFDMFC is sensitive to its orientation along gravity.
7. Both anode electrode reaction of direct hydrocarbon electro-oxidation and the cathode electrode reaction of oxygen electro-reduction are sluggish in the acidic medium as compared to the alkaline medium. To reach the minimum performance requirement, high loading levels of noble metal catalysts have to be used in the acidic medium for both anode and cathode, while in the alkaline medium, inexpensive catalysts have been developed.

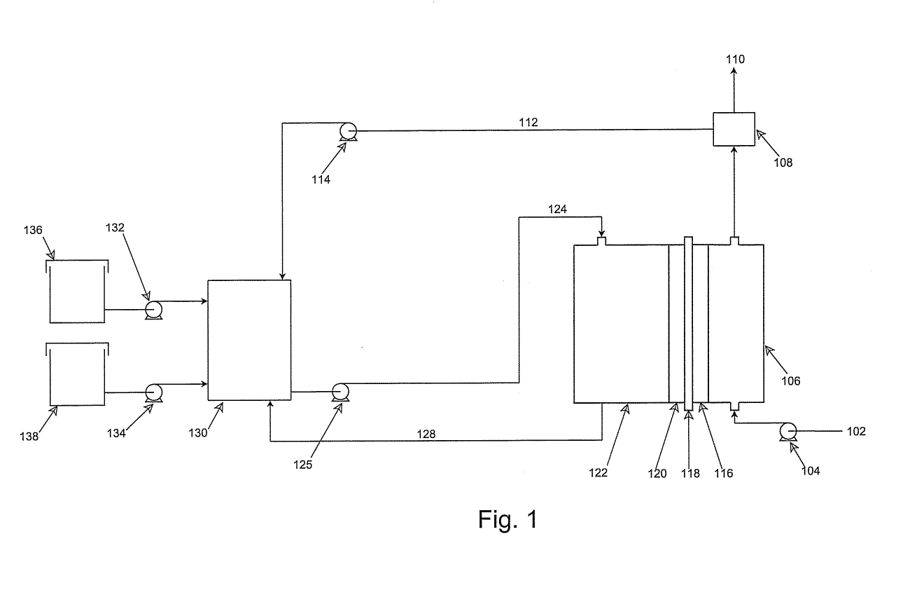

Similar to the LFDMFC, the prior art of a liquid feed direct hydrocarbon alkaline fuel cell (LFDHAFC) system using alkaline conducting medium between the anode and cathode is illustrated in FIG. 1. Concentrated or neat hydrocarbon fuel stored in fuel tank 136 is delivered to a fuel-water mixing tank 130 by a fuel pump 132. A measured amount of water is delivered to the fuel-water mixing tank 130 from the water tank 138 by a water pump 134 to reach a desired fuel concentration suitable for the fuel cell operation. An anode recirculation pump 125 is used to deliver the fuel solution from fuel-water mixing tank 130 via conduit 124 to the fuel cell anode, and the used fuel fluid is returned to the fuel-water mixing tank via a conduit 128 to form a recirculation loop. The liquid fuel solution has a direct contact with the fuel cell anode 120 within the anode chamber 112. The cell anode is separated from the cell cathode 116 by a hydroxyl ion conducting medium or membrane material 118. Fresh air 102 is delivered to the cell cathode 116 housed within the cathode chamber 106 by an air pump 104. The air exhaust is directed to a water-gas separator 108 to remove the liquid water, which is returned to the fuel-water mixing tank 130 via a conduit 112 by a water pump 114. After passing through the water-gas separator 108, the air exhaust is then released to atmosphere 110.

It becomes obvious that a LFDMFC using a protonic conducting membrane or a LFDHAFC using hydroxyl ion conducting medium has many unavoidable disadvantages such as a low system energy density due to the need of carrying a fuel solution of low fuel concentration and pure water, complicated system components, system control for water and thermal management etc. Such a direct liquid feed hydrocarbon fuel cell system is utterly unsuitable for many portable power applications, where light weight, high energy density, simple and reliable operation, safety, and cost are most important and determinant factors. The direct alkaline hydrocarbon fuel cell revealed in this invention is entirely different for the liquid fuel feed fuel cell systems found in the prior art in that it is fed by the fuel vapor from a highly concentrated hydrocarbon fuel aqueous solution or from neat hydrocarbon fuel. This new alkaline hydrocarbon fuel cell system will be referred to as vapor feed direct hydrocarbon alkaline fuel cell (VFDHAFC), in differentiating it from the traditional liquid fuel feed fuel cell system, which has many disadvantages mentioned above.

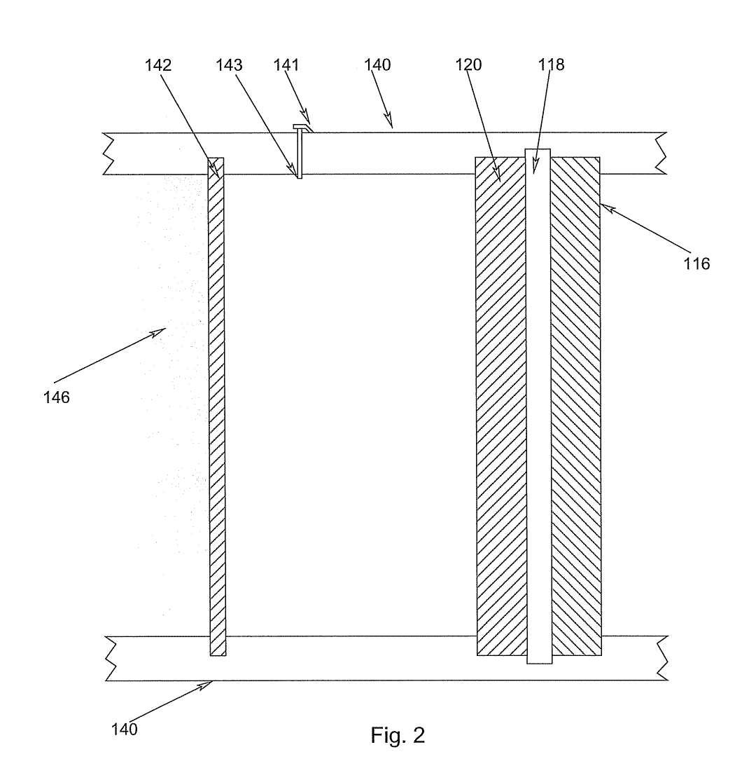

The fuel feed to the fuel cell electrode of a VFDHAFC is schematically illustrated in FIG. 2. Liquid concentrated fuel solution or neat fuel 146 is in contact with a micro-porous material or a polymer membrane material 142, which permeates the fuel passing through and emerging at the opposite side as fuel vapor. The fuel vapor thus generated is presented to the fuel cell anode 120, which is separated from the fuel cell cathode 116 by a hydroxyl conducting polymer electrolyte membrane 120. There is a pine hole 143 placed in the shell 140 enclosing the space between the fuel evaporating membrane 142 and fuel cell anode 120. The carbon dioxide generated from the anode electrode reaction is released through the pin hole 143 after it reaches a positive pressure determined by a spring loaded valve141. The valve 141 ensures a positive pressure build up within the cell anode side to prevent air access to the cell anode and to provide a hydrodynamic pressure to facilitate the water transport from the cell anode 120 to cell cathode 116 through the polymer electrolyte membrane 118.

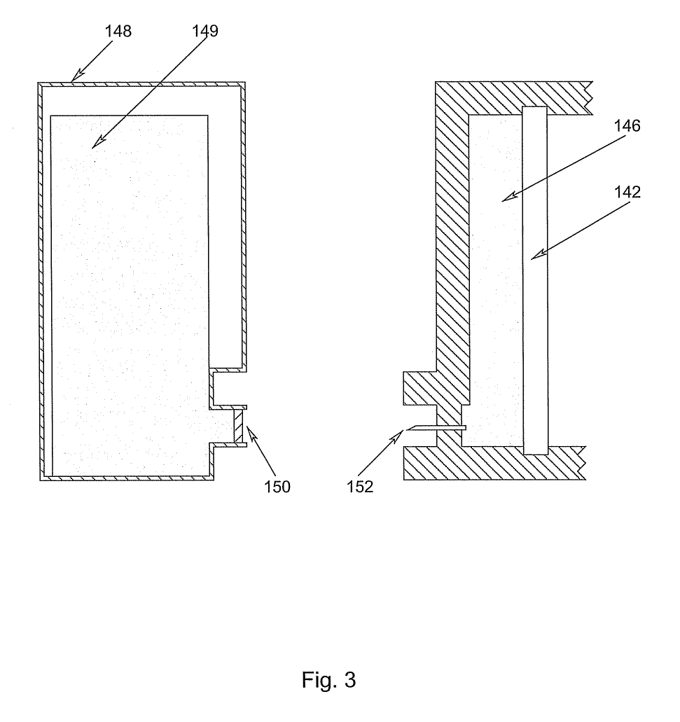

FIG. 3 illustrates an embodiment of a method of fuel feed from a fuel cartridge to a LFDHAFC. The liquid fuel 149 stored in a fuel cartridge 148 is delivered to the fuel cell after the fuel cartridge 148 is inserted into the fuel cell, resulting the septum 150 of the fuel cartridge 148 being penetrated by a needle 152. The liquid fuel flows through the needle and comes in direct contact with the fuel evaporating membrane 142.

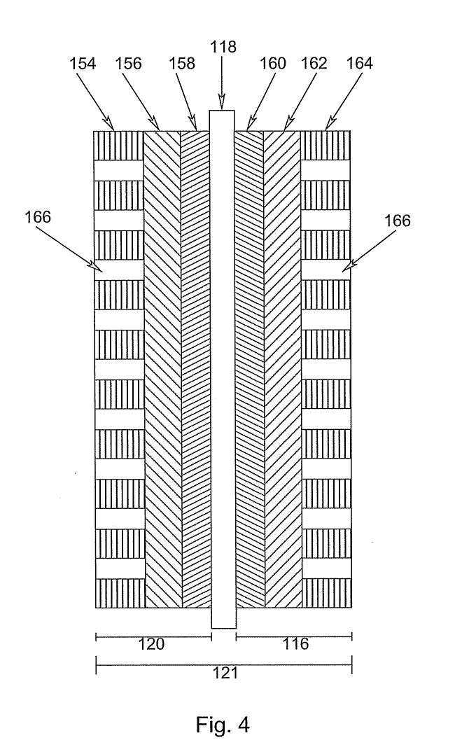

FIG. 4 illustrates the membrane electrode assembly (MEA) of a VFDHAFC. The MEA 118 consists of a hydroxyl ion conducting polymer electrolyte membrane 118, which is sandwiched by an anode catalyst layer 158, and a cathode catalyst layer 160. An anode backing layer 156 forms intimate contact with the anode catalyst layer 158, and a cathode backing layer 162 forms intimate contact with the cathode catalyst layer 160. Anode current collector 166 and cathode current collector 166 compresses the entire assembly and distributing reactants over the active electrode area. The fuel cell reactants and products are introduced to the cell electrodes and released from the cell electrodes through multiple openings 166 through the current collector materials, respectively. With an electrical conducting material as the current collector, the electrical current generated from the fuel cell operation can be collected at the cell edge in a direction parallel to the plane of current collector or in a bipolar configuration through the current collector.

To enhance the desired water transport through the polymer electrolyte membrane 118, it is highly advantageous to make the anode catalyst layer 158 highly hydrophobic and the cathode catalyst layer 160 highly hydrophilic. The capillary force developed within the microporous and hydrophobic anode catalyst layer tends to push water into the polymer electrolyte membrane, and the capillary force developed within the microporous and hydrophilic cathode catalyst layer tends to pull water from the polymer electrolyte membrane. To minimize excess water loss from the membrane, it may be desirable to use an anode backing and a cathode backing that are highly hydrophobic. Such a backing electrode can be made from a carbon powder material (Vulcan XR-72) and a high content (25 to 75%) of PTFE.

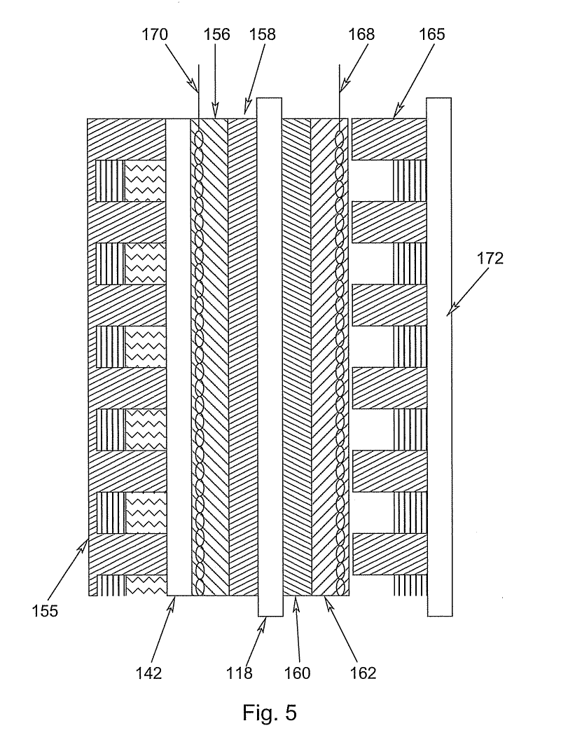

FIG. 5 is an alternative embodiment of the MEA shown in FIG. 4. In FIG. 5, the metal wire meshes 170, and 168 imbedded within the backing layers 156 and 162 are used for the function of current collection. Additionally, the fuel evaporating membrane 142 is placed directly over the anode backing layer 156. The functions of compression and reactant distribution over the active area can be carried out by using a variety of materials, including non-electrical conducting plastic materials.

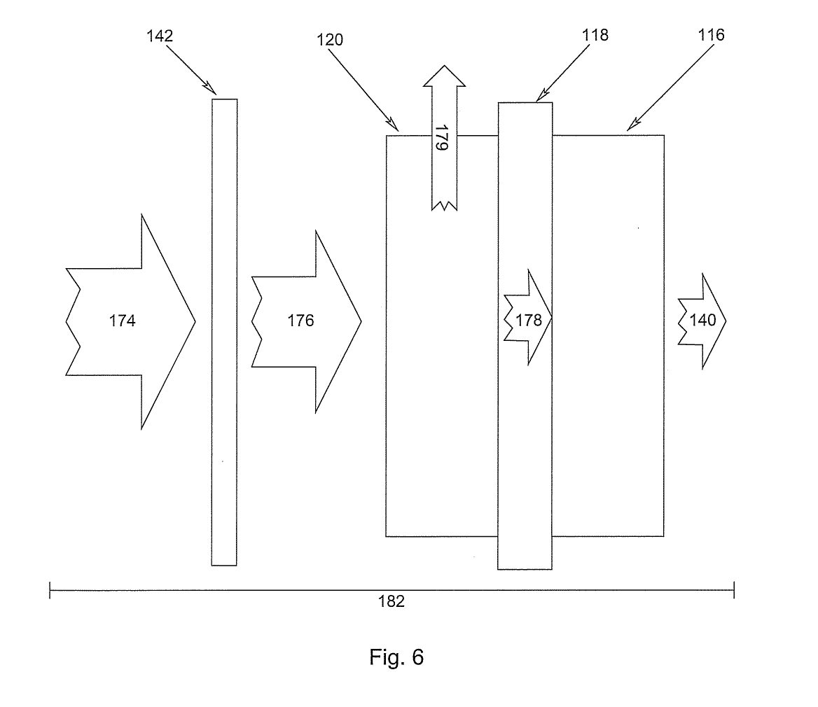

The paths of fuel transport to the cell anode and reaction product carbon dioxide release are illustrated in FIG. 6. The liquid fuel 174 is delivered to the fuel cell where it comes in direct contact with the fuel evaporating membrane 142. After passing through the fuel evaporating membrane 142, fuel vapor 176 is presented to the cell anode 120. Part of the anode reaction product carbon dioxide 179 is released through the pin hole opening 143, with the remaining part 178 passing through the polymer electrolyte membrane 118, and through the cell cathode 116 to be removed by the air exhaust stream. The entire components are collectively named as the fuel feed and fuel cell assembly 182.

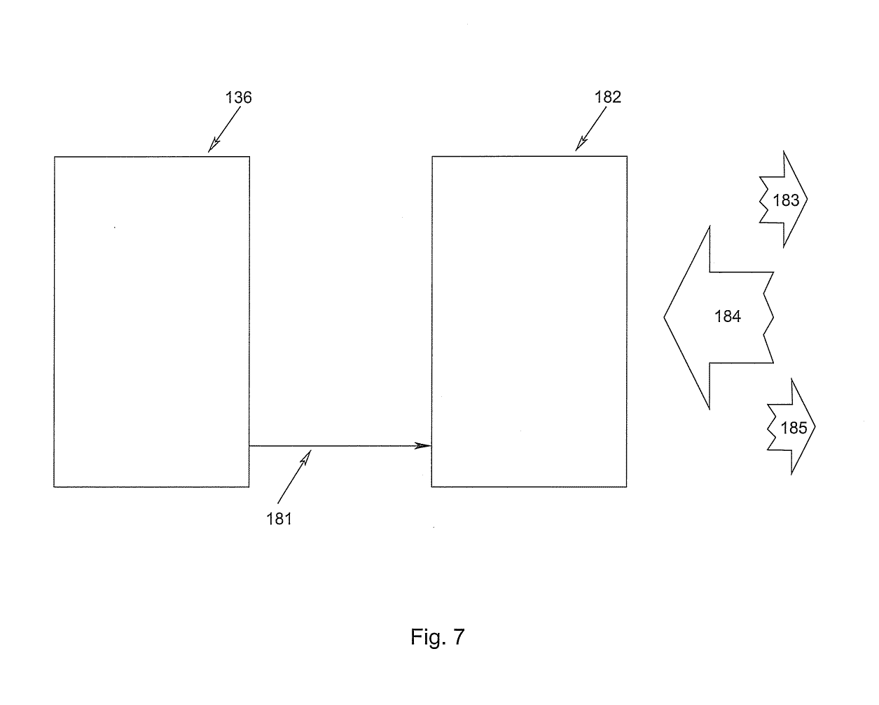

FIG. 7 is a block diagram illustrating a complete fuel cell system with an air breathing cathode. The fuel from the fuel cartridge 136 is delivered to the fuel feed and fuel cell assembly 182 via a conduit 181. Oxygen 184 from the ambient air is delivered to the fuel cell cathode by its natural diffusion. The products, carbon dioxide 183, and water vapor 185, of fuel cell electrode reactions are also released at the cell cathode by their natural diffusions. In general, air breathing based fuel cell systems are suitable for applications with a low power density requirement for fuel cell to be operated around ambient temperature (<50° C.). Under such operating conditions, water and fuel losses through evaporation at the cell cathode are relative low, and the needs for water and fuel vapor recovery are removed.

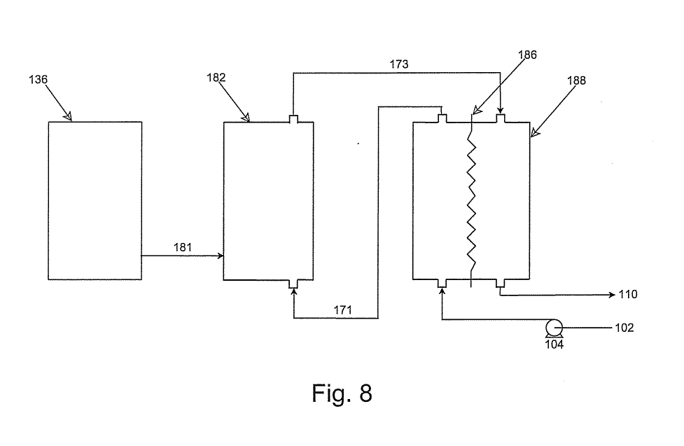

To meet applications where the high fuel cell power density is required, a VFDHAFC fuel cell system can be operated at a high cell temperature and with an active air feed, as illustrated in FIG. 8. The fresh air 102 is delivered to the cell cathode within the fuel feed and fuel cell assembly 182 by an air pump 104. To recover the fuel and water vapor in the cathode exhaust 173, a polymer membrane based moisture exchanger 188 is used. Within the moisture exchanger 188, a thin polymer membrane, such as Nafion membrane, separates the outgoing cathode exhaust 173 stream, which is hot and wet, with the incoming fresh air stream 102, which is cold and dry. The two streams flow in counter flow pattern at the two sides of the polymer membrane surface. As the result, the water and fuel vapor, as well as heat, are substantially retained in the incoming air stream 171. The high water and fuel vapor in the incoming air stream 171 minimizes the concentration gradient governing the evaporating rate from the cathode surface, enabling the fuel cell system to be operated at a higher cell temperature (>78° C.).

### Example of a VFDHAFC

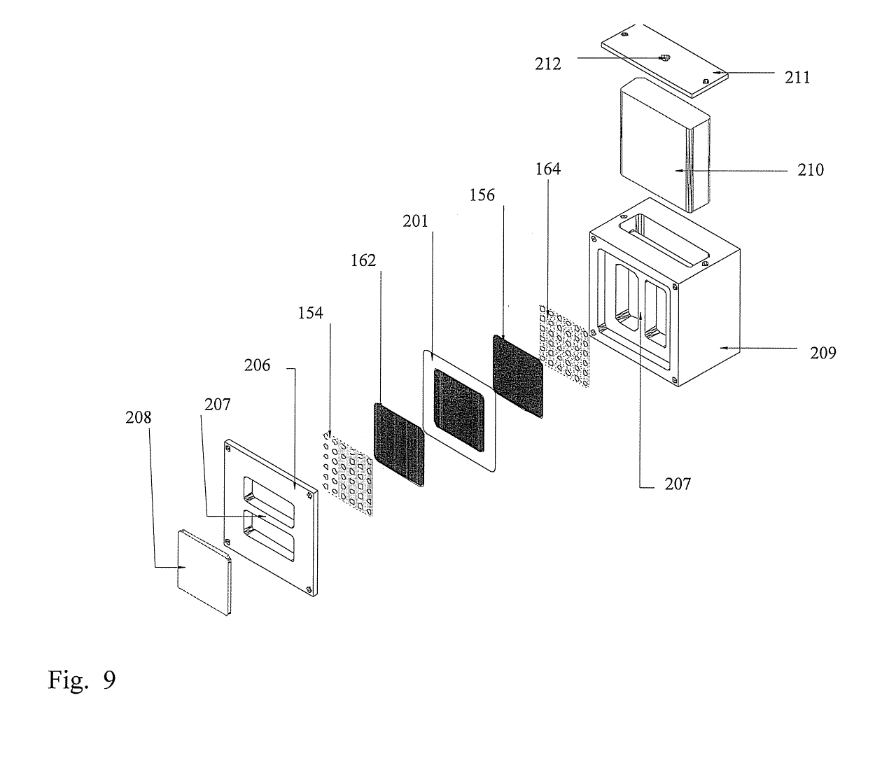

FIG. 9 shows the cell components for an air breathing VFDHAFC unit containing only a single cell. The air breathing VFDHAFC described here consists of a membrane electrode assembly 201, anode backing 156 and cathode backing 162, metal current collectors 54,164, reinforcement bars 206, a compression plate 207, air side filter 208, fuel reservoir containing highly concentrated hydrocarbon fuel or neat hydrocarbon fuel. The fuel reservoir is formed by the cell body 209, a body of neat hydrocarbon fuel stored in a bag 210 to be placed inside the methanol reservoir container, and a cover 211 to seal the anode compartment from the atmospheric air. Each of these components is further described in details below. Membrane electrode assembly (MEA) 201: The MEA can be made by coating the anode ink and cathode ink directly on to each surface of a OH— conducting membrane, such as a OH— conducting polymer electrolyte membrane, in particular, by various methods, such as spray coating, electrostatic dry powder coating, screen coating and many other methods. The anode ink can be made from Hypermec catalysts or catalysts containing noble metals such as Pt, Ru, Pd, either supported on carbon or unsupported. The cathode ink can be made from Hypermec cathode catalyst or Pt catalyst, with OH— conducting ionomer solution.

Anode backing 156: A highly hydrophobic single sided carbon cloth backing or carbon paper backing can be used to contact the active area at the anode side of the MEA. The anode backing can be made by coating the backing substrate (carbon paper or carbon clothe, or other porous and electronic conducting material, such as sintered porous metal sheet) with a microporous layer, which is formed by a mixture of PTFE and carbon power. The PTFE content in the microporous layer is directly related the hydrophobicity of the anode backing, and is in generally in the range of 25 to 80 wt. %, and preferably between 50 to 75 wt. %. Also, the pore size of the microporous layer is controlled to create the desired capillary force, and in general in the range of 0.1 to 1 um in diameter, and preferable between 0.1 and 0.4 um. The highly hydrophobic anode backing is desirable to promote water flux across the membrane from cell anode to cell cathode.
Cathode catalyst layer and cathode backing 162: A highly hydrophilic cathode catalyst layer and highly hydrophobic cathode backing are used at the cell cathode. To render the cathode catalyst layer hydrophilic, OH— conductive ionomer is mixed with the cathode catalyst to form the cathode catalyst ink. The anode backing can be made by coating the backing substrate (carbon paper or carbon clothe, or other porous and electronic conducting material, such as sintered porous metal sheet) with a microporous layer, which is formed by a mixture of PTFE and carbon power. The PTFE content in the microporous layer is kept at relatively high level, and is in generally in the range of 25 to 75 wt. %, and preferably between 50 to 60 wt. %.
Metal current collectors 154,164: The two current collectors that sandwich the MEA were made from perforated metal sheets, which have been corrugated further into folds of ridges and valleys. The corrugation gives the metal current collectors good mechanical strength against the bending stress from compressing the MEA, and the perforation creates the needed openness to allow the reactants (methanol and air) reaching the catalyst layers. In this application, the perforated area covers up to 50% the total metal sheet area. In an assembled methanol fuel cell, the anode metal current collector 154 compresses the anode backing 156, MEA 201, the cathode backing 162 against the cathode metal current collector 164. The two metal current collectors are placed in a cross fashion along their corrugation folds.
Reinforcement bars 206,207: The metal current collectors 154,164 will be further compressed by two plates containing reinforcement bars 206, 207. The space between the bars is more widely separated than the corrugation folds of the metal current collectors 154,164. The reinforcement bars run across the corrugation folds of the metal current collectors. The assembly consists of one MEA 201 sandwiched by anode backing 156 and cathode backing 162, then by metal current collector 154,164 and then by reinforcement bars 206,207 is called collectively as the electrode assembly 121.
Air side filter208: The air side filter is a piece of porous polypropylene paper, or porous PTFE membrane material, covering the openings of the reinforcement bars. Out side air needs to pass through this filter to reach the cathode backing and then the cathode catalyst layer. The purpose of this filter is to keep dirt particles out and keep water moisture within the cell while allowing the natural diffusion of oxygen from air into the air-breathing cell.
Hydrocarbon fuel reservoir container formed by the cell body 209: Hydrocarbon fuel reservoir container is formed by the cell body 209 and is sealed by electrode assembly 121 and cell cover 211 to form a closed space.
A body of neat hydrocarbon fuel stored inside a porous evaporative bag 210: A body of neat hydrocarbon fuel is stored inside a porous evaporative bag that allows a steady evaporation of fuel through bag wall. The fuel feed rate can be controlled by the area of fuel permeable section of the fuel bag. The bag containing the neat hydrocarbon or a highly concentrated hydrocarbon solution forms a fuel reservoir placed inside the fuel reservoir container.
Cover Plate 211: A cover plate is used to seal the anode compartment containing methanol reservoir and methanol vapor from the atmospheric air, so that it is possible to build a positive pressure within the anode compartment with the CO2 produced. A positive and steady CO2 pressure is maintained by releasing CO2 through pinholes in the cover plate or through OH— conductive polymer membrane. Such a positive pressure enhances water transport from cell anode, where it is produced, to cell cathode where it is consumed.

In the following description, ethanol is used as the example of hydrocarbon fuel. However, it has been demonstrated that hydrocarbon fuels such as methanol, ethanol, glycerol, ethylene glycol, and even gasoline can be used as direct fuel with Hypermec anode and cathode catalysts in an alkaline fuel cells.

From the ethanol reservoir placed within the anode compartment, ethanol vapor is formed after passing through an evaporating membrane or a porous medium that separates the liquid ethanol fuel from its vapor. At the steady state of operation, the ethanol vaporization rate matches its consumption rate at anode catalyst layer. It is worthwhile to emphasize the additional advantage of Hypermec cathode catalyst for its selective reduction of oxygen from air without catalyzing the oxidization of fuel that may permeate through the membrane. In such a case, the fuel feed rate is substantially determined by its consumption at cell anode. The fuel loss through crossover the polymer electrolyte membrane minimized by the cathode catalyst selectivity offered by Hypermec cathode catalyst, and is determined by the minimum loss rate through fuel evaporation at cell cathode. The anode electrode reaction is:

CH₃CH₂OH+12OH⁻→2CO₂+9H₂O+12e⁻

and the cathode electrode reaction is:

3O₂+6H₂O+12e⁻→12OH⁻

and the combined reaction is:

CH₃CH₂OH+3O₂=2CO₂+3H₂O

Water generated from the anode electrode reaction need to be moved back to the cell cathode to sustain the need of water for the cathode electrode process. In this invention, the backward water movement from cell cathode to cell anode is made possible, as this process is enhanced by enhancing several factors. These are:
1. The water concentration gradient between the cathode side of the membrane and the anode side of the membrane causes water diffuse from the anode to the cathode. The counter flow of water by diffusion and by electro-osmotic drag of OH— can reach a natural balance within the membrane. With a thin membrane, a sufficient water level can be maintained within the membrane for both the needs of adequate OH— conduction and the cathode electrode process.
2. By using a highly hydrophilic cathode backing and a highly hydrophobic anode backing, a hydrodynamic pressure of water that promotes water transport from anode to cathode can be created.
3. The hydrocarbon fuel vapor can be produced from the reservoir containing a hydrocarbon solution of high concentration or neat hydrocarbon fuel in several ways, which are listed below as examples for illustration but not necessarily for completeness. One way to generate the vapor is by natural evaporation through a porous bag containing the hydrocarbon solution of high hydrocarbon concentration or neat hydrocarbon fuel in the liquid form. The porosity of the bag prevents hydrocarbon fuel transport through it in the liquid form, but allows the fuel molecules diffuse through and emerge as vapor. A stirring fan can be used to enhance vapor transport to the cell anode, if it is needed for a large stack to circulate the vapor in the anode chamber and manifold to create a uniform distribution over the active electrode area. The porous media that separates the liquid form hydrocarbon fuel in the fuel reservoir from the vapor at the anode electrode side can also be placed right against the electrode current collector, which can also function as the mechanic support to compress the electrode assembly. In another embodiment, the porous medium and backing electrode can be combined into one cell component by using microporous metal sheet, such as a porous stainless steel sheet, or porous nickel foam that can be formed from sintering fine metal particles. The porous metal sheet can also be coated with a layer of carbon powder and PTFE microporous layer for its better contacting against the catalyst layer.

One of the important features that distinguish a VFDHAFC from a LFDMFC is that in a VFDHAFC, the CO₂ gas generated from anode electrode reaction at the anode catalyst layer will not be mixed with the liquid fuel feed stream. By creating a positive pressure, the CO2 is released through pinholes located between the cell anode and evaporative membrane, or is allowed to push through the MEA and released at cell cathode. Because of this feature, the operation of a VFDHAFC is insensitive to its orientation along gravity. The positive pressure build at the anode compartment also facilitates the water movement from the cell anode, where it is generated, to the cell cathode, where it is consumed.

### Example of VFDHAFC Stack and Power System

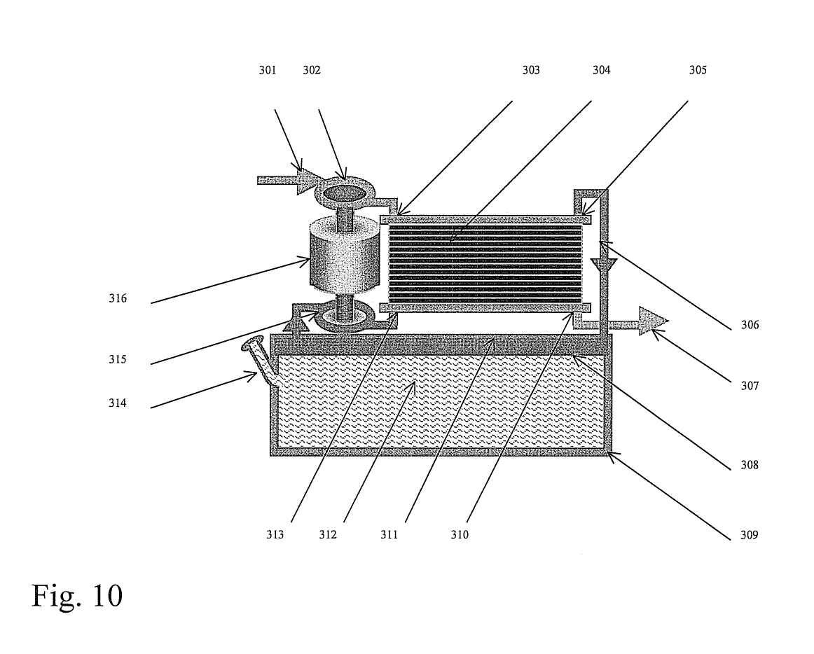

FIG. 10 shows a schematic diagram of a VFDHAFC stack 304 fed with forced hydrocarbon vapor on the anode and forced air on the cathode. A single pump 316 with a fuel vapor pump head 315 and air pump head 302 circulates fuel vapor and pumps atmospheric air (1) through the stack 304 at fixed ratio of flow rates. In the fuel tank 309, a solution of high hydrocarbon fuel concentration or neat hydrocarbon fuel is stored in liquid form 312. A polymer or other porous medium 308 separates the liquid form hydrocarbon fuel 312 from its vapor 311. The fuel vapor enters stack 304 at the anode inlet 313, exits stack 304 at the anode outlet 305 and then was re-circulated over the porous medium 308 that separates the liquid form hydrocarbon fuel 312 from fuel vapor 311 in the fuel tank 309. The atmospheric air (1) is pumped into stack at the cathode inlet 303 and exits at the cathode outlet 310. The cathode exhaust 307 contains reaction products of CO₂ and water vapor.

It should be understood by those skilled in the art that the invention described herein provides an improved direct oxidation fuel cell which is simplified and exhibits fewer power losses, as it does not require the use of pumps and other recirculation components. It also allows adjustments to the fuel concentration which enables fuel to be added only as it is consumed. Thus, problems associated with methanol crossover and water carryover are reduced due to limiting the introduction of those fluids into the system.

The foregoing description has been directed to specific embodiments of the invention. It will be apparent, however, that other variations and other modifications may be made to the described embodiments, with the attainment of some or all of the advantages of such. Therefore, it is the object of the appended claims to cover all such variations and modifications as come within the true spirit and scope of the invention.

1. A direct oxidation fuel cell system, comprising:
(A) a fuel source;
(B) a direct oxidation fuel cell, having:
(i) a membrane electrode assembly, including;
(a) a anionic HO⁻ conductive, electronically non-conductive membrane electrolyte, having an anode face and an opposing cathode face; and
(b) a catalyst layer disposed in intimate contact on each of said anode face and said cathode face, whereby electricity-generating reactions occur upon introduction of an associated fuel from said fuel source including anodic electro-oxidation said fuel and hydroxide anions into carbon dioxide, water, and electrons, and a cathodic electro-reduction of electrons, water and oxygen from an associated source of oxygen, producing hydroxide anions; and
(ii) an anodic diffusion or backing layer disposed in intimate contact with said anode catalyst layer of said membrane electrode assembly and having a plurality of openings and paths therein to allow said associated fuel to pass through to said anode catalyst layer, as fuel is consumed at said anode catalyst layer;
(iii) a cathodic diffusion or backing layer disposed in intimate contact with said cathode catalyst layer of said membrane electrode assembly and having a plurality of openings and paths therein to allow oxygen to pass through to said cathode catalyst layer of said membrane electrode assembly;
(C) a fuel evaporative means disposed between the said fuel source and said anode diffusion layer, such that fuel from said fuel source emerging as fuel vapor, which can pass through said anodic diffusion layer to said anode catalyst layer;
(D) a fuel delivery assembly coupled between said fuel source and said fuel evaporative means in such a manner that as fuel is consumed at said anode catalyst layer, fuel is drawn into space between said fuel evaporative means and said fuel delivery assembly from said fuel source; and
(E) a load coupled across said fuel cell, said load providing a path for said electrons whereby electricity is provided as said electricity-generating reactions proceed.

2. The direct oxidation fuel cell system as defined in claim 1 further comprising means for evaporating off water produced at said cathode backing layer.

3. The direct oxidation fuel cell system as defined in claim 1 wherein said fuel source is highly concentrated hydrocarbon fuel and water solution without electrolyte.

4. The direct oxidation fuel cell system as defined in claim 1 wherein said fuel evaporative means is comprised of a microporous material or a polymer membrane, said fuel evaporative membrane being disposed generally parallel to said anodic diffusion layer, such that said fuel from said fuel source in liquid form passing through said fuel evaporative membrane and emerging as fuel vapor, which can pass through said anodic diffusion layer to said anode catalyst layer.

5. The direct oxidation fuel cell system as defined in claim 1 wherein said fuel evaporative means is alternatively comprised of using gelled fuel source placed inside anode compartment in adjacent to the said anode diffusion layer, said gelled fuel source provides fuel vapor, which can pass through said anodic diffusion layer to said anode catalyst layer.

6. (canceled)

7. The direct oxidation fuel cell system as defined in claim 6 wherein said fuel evaporative pad further includes a heating system to facilitate fuel evaporation, the said heating system can be substantially comprised of using waste heat from fuel cell reactions, or a combination of the waste heat with added electric heating, or a combination of the waste heat with heat from fuel combustion on a catalytic surface.

8. The direct oxidation fuel cell system as defined in claim 1 wherein said fuel delivery assembly is comprised of a fuel pump with conduits connecting to said fuel source and to said fuel evaporative means.

9. The direct oxidation fuel cell system as defined in claim 4 wherein said fuel delivery assembly is not needed, as the said fuel source is placed inside fuel cell anode compartment and in contact with said fuel evaporative membrane.

10. The direct oxidation fuel cell system as defined in claim 1 wherein said anode catalyst layer is comprised of a porous layer containing direct fuel electro-oxidation catalyst, either supported on an electronically conductive material or unsupported, ionomeric OH— conducting recast polymer, and PTFE wherein said PTFE content within the said anode catalyst layer is between 20 to 50 wt. % so that the said anode catalyst layer is highly hydrophobic.

11. The direct oxidation fuel cell system as defined in claim 10 wherein said direct fuel electro-oxidation catalyst is Hypermec anode catalyst.

12. (canceled)

13. The direct oxidation fuel cell system as defined in claim 1 wherein said cathode catalyst layer is comprised of a porous layer containing oxygen electro-reduction catalyst, either supported on an electronically conductive material or unsupported, ionomeric OH— conducting recast polymer, and PTFE wherein said PTFE content within the said cathode catalyst layer is between 5 to 15 wt. % so that the said cathode catalyst layer is substantially hydrophilic.

14. The direct oxidation fuel cell system as defined in claim 13 wherein said direct fuel electro-reduction catalyst is Hypermec cathode catalyst.

15. (canceled)

16. The direct oxidation fuel cell system as defined in claim 1 wherein said anode diffusion or backing layer is comprised of a microporous layer made with carbon particles bonded together with PTFE wherein said PTFE content within the said anode diffusion or backing layer is between 25 to 55 wt. % so that the said anode diffusion layer is substantially hydrophobic.

17. (canceled)

18. The direct oxidation fuel cell system as defined in claim 1 wherein said cathode diffusion or backing layer is comprised of a microporous layer made with carbon particles bonded together with PTFE wherein said PTFE content within the said cathode diffusion or backing layer is between 25 to 55 wt. % so that the said cathode diffusion layer is substantially hydrophobic.

19. (canceled)

20. The direct oxidation fuel cell system as defined in claim 1 further comprising a housing encapsulating said direct oxidation fuel cell, said housing having an inlet port for the introduction of fuel into said fuel cell.

21. The direct oxidation fuel cell system as defined in claim 20 further comprising a second port is defined in said housing into which fuel can be introduced, or removed, from the fuel cell.

22. (canceled)

23. The direct oxidation fuel cell system as defined in claim 1 wherein said anionic OH— conductive membrane is comprised substantially of Tokoyama membrane.

24. The direct oxidation fuel cell system as defined in claim 1 wherein said fuel cell uses OH— conductive polymer electrolyte membrane with an anode catalyst layer and a cathode catalyst layer attached on the two major surfaces to form membrane electrode assembly, and is operated by feeding the cell anode with a hydrocarbon fuel vapor from a neat hydrocarbon fuel or an aqueous solution of very high concentration of the hydrocarbon fuel (hydrocarbon:water molar ratio>=1:1), and by feeding the cell cathode with air or oxygen, either passive or forced air flow.

25.-34. (canceled)
